(19) United States
(12) Patent Application Publication
(10) Pub. No.: US 2026/0055250 A1
(43) Pub. Date: Feb. 26, 2026

(54) PREPARATION METHOD, PRODUCT, AND APPLICATION OF MODIFIED MELAMINE FOAM

(71) Applicant: FoamTech (Zhejiang) New Materials Co., Ltd, Yiwu (CN)

(72) Inventors: Yangyang Li, Yiwu (CN); Xuezi Fan, Yiwu (CN)

(21) Appl. No.: 18/813,038

(22) Filed: Aug. 23, 2024

(51) Int. Cl. C08J 9/14; B29B 7/82; B29B 7/88; B29B 13/08; B29B 15/00; B29K 105/00; B29K 105/04; B29L 31/30; C08G 18/08; C08G 18/54; C08G 18/76; C08J 9/00; C08K 3/32; C08K 5/42; C08K 7/26; C08K 13/04

(52) U.S. Cl. CPC C08J 9/141; B29B 7/82; B29B 7/88; B29B 13/08; B29B 15/00; C08G 18/0871; C08G 18/544; C08G 18/7671; C08J 9/0095; C08K 13/04; B29K 2105/0061; B29K 2105/045; B29K 2995/0015; B29K 2995/0063; B29K 2995/0077; B29L 2031/3064; B29L 2031/3076; C08J 2203/14; C08J 2375/12; C08K 2003/323; C08K 5/42; C08K 7/26

(57) ABSTRACT

The present invention pertains to the field of functional materials technology, specifically relating to a preparation method, product, and application of modified melamine foam. The method described in this invention is simple, does not require special equipment or process conditions, and is easy to scale up for industrial production. The melamine foam produced by this method features a high open-cell rate and low density.

### TECHNICAL FIELD

The invention relates to the field of functional materials technology, specifically to a preparation method, product, and application of modified melamine foam.

### BACKGROUND

Melamine foam is a soft, foamed material made from melamine resin, characterized by a three-dimensional hexagonal open-cell structure. This structure imparts self-extinguishing properties, excellent thermal insulation, and sound absorption. Additionally, its open-cell structure makes it lightweight and capable of maintaining its properties across a range of temperatures. Due to its outstanding sound absorption and thermal insulation properties, melamine foam is used in various construction projects. However, to enhance its suitability for applications in aircraft or high-speed trains, further improvements in its sound absorption and thermal insulation capabilities are required.

### SUMMARY

Based on the above content, the invention provides a preparation method, product, and application of modified melamine foam. The invention introduces aerogel during the melamine-formaldehyde resin foaming process to improve the open-cell rate and density of melamine foam, thereby enhancing its sound absorption and thermal insulation properties.

To achieve the above objectives, the invention provides the following solution:
Technical Scheme 1: A preparation method for modified melamine foam, including the following steps:
Mix tetraethyl orthosilicate with deionized water, sodium dodecylbenzenesulfonate, and phosphoric acid at room temperature to obtain a sol.
Mix sodium dodecylbenzenesulfonate, methanol, and n-hexane to obtain a mixed solution.
Mix the sol with the mixed solution and allow it to stand to obtain a gel; then freeze-dry the gel to obtain an aerogel.
Perform a prepolymerization reaction with melamine and formaldehyde to obtain a prepolymer.
Add the aerogel, emulsifier, diphenylmethane diisocyanate, propylene glycol, foaming agent, and flame retardant to the prepolymer and perform microwave foaming to obtain the modified melamine foam.

### In Some Embodiments of the Invention:

The mass ratio of tetraethyl orthosilicate to deionized water, sodium dodecylbenzenesulfonate, and phosphoric acid is 1:4:0.02:0.05.

The mass ratio of sodium dodecylbenzenesulfonate, methanol, and n-hexane is 1:(10-15): 200.

The mass ratio of the sol to the mixed solution is 1:2; the standing time is specifically at 45° C. for 3.5 hours.

The mass-to-volume ratio of melamine to formaldehyde is 1 g: 1.5 mL; before adding the aerogel to the prepolymer, it also includes a step of grinding the aerogel and passing it through a 100-mesh sieve; the mass ratio of aerogel to prepolymer is 1:20.

The emulsifier is sodium dodecylbenzenesulfonate; the foaming agent is n-pentane; the flame retardant is ammonium polyphosphate.

The mass ratio of prepolymer to emulsifier, diphenylmethane diisocyanate, propylene glycol, foaming agent, and flame retardant is 130:7:15:(3-4):(5-6):4.
Technical Scheme 2: Modified melamine foam prepared using the above method.
Technical Scheme 3: Application of the modified melamine foam in the preparation of thermal insulation components for aircraft or high-speed trains.

Technical Effects of this invention are described as follows:

The method is simple, does not require special equipment or process conditions, and is easy to scale up for industrial production.

By introducing high specific surface area and high porosity aerogels into the melamine-formaldehyde resin foaming process, the method can promote foaming and improve the open-cell rate of melamine foam. This further reduces the density of melamine foam, enhancing its sound absorption and thermal insulation properties

### BRIEF DESCRIPTION OF DRAWINGS

In order to more clearly illustrate the embodiments of the present invention or the technical solutions in the prior art, the following will briefly introduce the drawings required for use in the embodiments. Obviously, the drawings described below are only some embodiments of the present invention. For ordinary technicians in this field, other drawings can be obtained based on these drawings without creative work.

FIG. 1 is a microscopic structure diagram of the modified melamine foam prepared in Embodiment 2 of the present invention.

### DETAILED DESCRIPTION OF EMBODIMENTS

Now, various exemplary embodiments of the present invention are described in detail. This detailed description should not be considered as limiting the present invention, but should be understood as a more detailed description of certain aspects, features and embodiments of the present invention.

It should be understood that the terms described in the present invention are only for describing specific embodiments and are not used to limit the present invention. In addition, for the numerical range in the present invention, it should be understood that each intermediate value between the upper and lower limits of the range is also specifically disclosed. The intermediate value in any stated value or stated range, and each smaller range between any other stated value or intermediate value in the stated range are also included in the present invention. The upper and lower limits of these smaller ranges may be independently included or excluded in the range.

Unless otherwise specified, all technical and scientific terms used herein have the same meanings as commonly understood by those skilled in the art in the field to which the present invention relates. Although the present invention describes only preferred methods and materials, any methods and materials similar or equivalent to those described herein may also be used in the implementation or testing of the present invention. All documents mentioned in this specification are incorporated by reference to disclose and describe the methods and/or materials related to the documents. In the event of a conflict with any incorporated document, the content of this specification shall prevail.

It is obvious to those skilled in the art that various modifications and changes may be made to the specific embodiments of the present invention description without departing from the scope or spirit of the present invention. Other embodiments obtained from the present invention description are obvious to the technician. The present invention description and embodiments are only exemplary.

The terms “include”, “including”, “have”, “contain”, etc. used in this article are open-ended terms, which means including but not limited to.

Aspect One of the Invention: A preparation method for modified melamine foam, including the following steps:

Mix tetraethyl orthosilicate with deionized water, sodium dodecylbenzenesulfonate, and phosphoric acid at room temperature to obtain a sol.

Mix sodium dodecylbenzenesulfonate, methanol, and n-hexane to obtain a mixed solution.

Combine the sol with the mixed solution and allow it to stand to obtain a gel; then freeze-dry the gel to obtain an aerogel.

Perform a prepolymerization reaction with melamine and formaldehyde to obtain a prepolymer.

Add the aerogel, emulsifier, diphenylmethane diisocyanate, propylene glycol, foaming agent, and flame retardant to the prepolymer and perform microwave foaming to obtain the modified melamine foam.

In this invention, during the foaming process of melamine-formaldehyde resin, the aerogel can adsorb into the resin melt, improving the foaming rate of the melamine foam, reducing its density, and enhancing its thermal insulation and sound absorption properties. This makes it suitable for applications such as vibration-damping and noise-reducing panels in aircraft or fire-resistant and insulating floors in high-speed trains.

### In Some Embodiments:

The mass ratio of tetraethyl orthosilicate to deionized water, sodium dodecylbenzenesulfonate, and phosphoric acid is 1:4:0.02:0.05.

The mass ratio of sodium dodecylbenzenesulfonate, methanol, and n-hexane is 1: (10-15): 200.

The mass ratio of the sol to the mixed solution is 1:2; the standing time is specifically 45° C. for 3.5 hours.

The mass-to-volume ratio of melamine to formaldehyde is 1 g:1.5 mL; before adding the aerogel to the prepolymer, it also includes a step of grinding the aerogel and passing it through a 100-mesh sieve; the mass ratio of aerogel to prepolymer is 1:20.

Excessive or insufficient amounts of aerogel can affect the density and foaming rate of the melamine foam. This invention explores a range of aerogel-to-prepolymer mass ratios from (0.5-3):20, with results showing that a ratio of 1:20 provides the best foaming rate and density for the melamine foam.

The emulsifier is sodium dodecylbenzenesulfonate; the foaming agent is n-pentane; the flame retardant is ammonium polyphosphate.

The mass ratio of prepolymer to emulsifier, diphenylmethane diisocyanate, propylene glycol, foaming agent, and flame retardant is 130:7:15:(3-4):(5-6):4.

The other aspect of the invention: Modified melamine foam prepared using the above method.

The third aspect of the invention: Application of the modified melamine foam in the preparation of thermal insulation components for aircraft or high-speed trains.

In the implementation embodiments of this invention, all materials and reagents used, unless otherwise specified, can be obtained through commercial sources.

The following embodiments further illustrate the invention.

### Embodiment 1

Step 1: Mix tetraethyl orthosilicate with deionized water, sodium dodecylbenzenesulfonate, and phosphoric acid in a mass ratio of 1:4:0.02:0.05 at room temperature to obtain a sol. Mix sodium dodecylbenzenesulfonate, methanol, and n-hexane in a mass ratio of 1:15:200 to obtain a mixed solution. Combine the sol with the mixed solution in a mass ratio of 1:2, then allow it to stand at 45° C. for 3.5 hours to obtain a gel. Freeze-dry the gel to obtain an aerogel.
Step 2: Mix melamine and formaldehyde in a mass-to-volume ratio of 1 g: 1.5 mL and perform a prepolymerization reaction for 15 minutes to obtain a prepolymer. Crush the aerogel and sieve it through a 100-mesh screen, then add it to the prepolymer. Add sodium dodecylbenzenesulfonate, diphenylmethane diisocyanate, propylene glycol, n-pentane, and ammonium polyphosphate, mix thoroughly, and perform microwave foaming. After curing and shaping, obtain the modified melamine foam. The mass ratio of aerogel to prepolymer is 1:20, and the mass ratio of prepolymer to emulsifier, diphenylmethane diisocyanate, propylene glycol, foaming agent, and flame retardant is 130:7:15:3:5:4.

Performance testing of the modified melamine foam prepared in this embodiment shows that the foam has an open-cell rate of 99.8%, a density of 5.4 kg/m³, and a tensile strength of 0.086±0.003 MPa.

### Embodiment 2

Step 1: Mix tetraethyl orthosilicate with deionized water, sodium dodecylbenzenesulfonate, and phosphoric acid in a mass ratio of 1:4:0.02:0.05 at room temperature to obtain a sol. Mix sodium dodecylbenzenesulfonate, methanol, and n-hexane in a mass ratio of 1:10:200 to obtain a mixed solution. Combine the sol with the mixed solution in a mass ratio of 1:2, then allow it to stand at 45° C. for 3.5 hours to obtain a gel. Freeze-dry the gel to obtain an aerogel.
Step 2: Mix melamine and formaldehyde in a mass-to-volume ratio of 1 g:1.5 mL and perform a prepolymerization reaction for 15 minutes to obtain a prepolymer. Crush the aerogel and sieve it through a 100-mesh screen, then add it to the prepolymer. Add sodium dodecylbenzenesulfonate, diphenylmethane diisocyanate, propylene glycol, n-pentane, and ammonium polyphosphate, mix thoroughly, and perform microwave foaming. After curing and shaping, obtain the modified melamine foam. The mass ratio of aerogel to prepolymer is 1:20, and the mass ratio of prepolymer to emulsifier, diphenylmethane diisocyanate, propylene glycol, foaming agent, and flame retardant is 130:7:15:4:6:4.

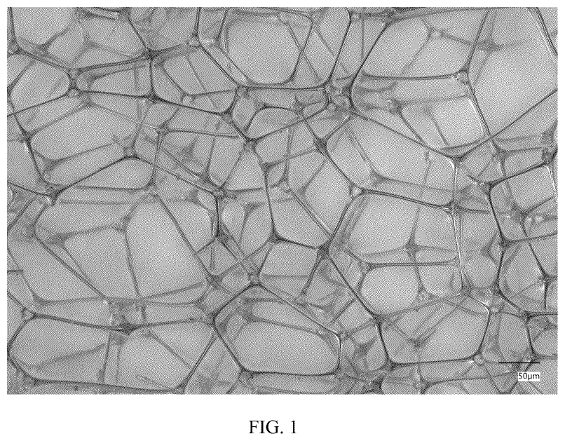

The microscopic structure of the modified melamine foam prepared in this embodiment is shown in FIG. 1. Performance testing of the foam shows that it has an open-cell rate of 99.9%, a density of 5.1 kg/m³, and a tensile strength of 0.086±0.004 MPa.

The embodiments described above are only descriptions of the preferred modes of the present invention, and are not intended to limit the scope of the present invention. Without departing from the design spirit of the present invention, various modifications and improvements made to the technical solutions of the present invention by ordinary technicians in this field should all fall within the protection scope determined by the claims of the present invention.

What is claimed is:

1. A method for preparing modified melamine foam, comprising the following steps: mix tetraethyl orthosilicate with deionized water, sodium dodecylbenzenesulfonate, and phosphoric acid at room temperature to obtain a sol; mix sodium dodecylbenzenesulfonate, methanol, and n-hexane to obtain a mixed solution; combine the sol with the mixed solution and allow the mixture to stand to obtain a gel. Subsequently, freeze-dry the gel to obtain an aerogel; perform a prepolymerization reaction with melamine and formaldehyde to obtain a prepolymer; add the aerogel, emulsifier, diphenylmethane diisocyanate, propylene glycol, foaming agent, and flame retardant to the prepolymer for microwave foaming to obtain the modified melamine foam.

2. The method for preparing modified melamine foam as claimed in claim 1, wherein, the mass ratio of tetraethyl orthosilicate to deionized water, sodium dodecylbenzenesulfonate, and phosphoric acid is 1:4:0.02:0.05.

3. The method for preparing modified melamine foam as claimed in claim 1, wherein, the mass ratio of sodium dodecylbenzenesulfonate, methanol, and n-hexane is 1:(10-15):200.

4. The method for preparing modified melamine foam according to claim 1, wherein, the mass ratio of the sol to the mixed solution is 1:2; the standing time is specifically 3.5 hours at 45° C.

5. The method for preparing modified melamine foam according to claim 1, wherein, the mass volume ratio of melamine to formaldehyde is 1 g:1.5 mL; prior to adding the aerogel to the prepolymer, the aerogel is further crushed and passed through a 100-mesh sieve; the mass ratio of aerogel to prepolymer is 1:20.

6. The method for preparing modified melamine foam according to claim 1, wherein, the emulsifier is sodium dodecylbenzenesulfonate; the foaming agent is n-pentane; the flame retardant is ammonium polyphosphate.

7. The method for preparing modified melamine foam according to claim 1, wherein, the mass ratio of the prepolymer to the emulsifier, diphenylmethane diisocyanate, propylene glycol, foaming agent, and flame retardant is 130:7:15:(3-4):(5-6):4.

8. A modified melamine foam prepared by the method as claimed in claim 1.

9. An application of the modified melamine foam in the preparation of thermal insulation components for aircraft or high-speed trains, as claimed in claim 8.
